(19) United States
(12) Patent Application Publication
(10) Pub. No.: US 2026/0021510 A1
(43) Pub. Date: Jan. 22, 2026

(54) SCREEN ASSEMBLY WITH LEAD EDGE RAMP

(71) Applicant: Schlumberger Technology Corporation, Sugar Land, TX (US)

(72) Inventors: Claire Rosaleen Galloway McLean, Edinburgh (GB); Eric Cady, Florence, KY (US)

(21) Appl. No.: 19/275,543

(22) Filed: Jul. 21, 2025

Related U.S. Application Data
(60) Provisional application No. 63/673,457, filed on Jul. 19, 2024.

(51) Int. Cl. B07B 1/40; B07B 1/46; E21B 21/06

(52) U.S. Cl. CPC B07B 1/40; B07B 1/4609; E21B 21/063

(57) ABSTRACT

Systems and methods including a screen assembly with a screen frame configured to couple to a screen filter. The screen frame includes a leading edge with a ramp to facilitate sliding the screen frame relative to a clamp of a shaker system. The leading edge may contain an engagement surface and/or mechanism that can help facilitate the clamping of the screen within the shaker system as well as allow for one screen to be engaged with another screen.

### CROSS-REFERENCED APPLICATIONS

The present application claims priority to and the benefit of U.S. Provisional Patent Application Ser. No. 63/673,457 titled “Screen assembly with Lead Edge Ramp” filed Jul. 19, 2024, the disclosure of which is incorporated herein by reference in its entirety.

### FIELD OF THE INVENTION

This invention generally relates to screens used to remove drilling debris that are found in synthetic muds used within the oil and gas industry. More specifically, it relates to the systems and methods of the sifting screens for use within shakers and the systems and methods for which said screens are inserted and connected within the shakers.

### BACKGROUND OF THE DISCLOSURE

Sifting screens used to remove debris such as rock and shale from synthetic drilling muds incorporate layers of woven wire mesh to separate out the debris from the synthetic mud. The screen is vibrated within the shaker and the mesh is subjected to wear from the vibration and the mud and debris. Replacing individual screens as the mesh fails is time consuming and delays the recovery of the mud. To improve the period of time over which any given screen remains operational, the screen is typically divided up into any number of rectangular openings or cells to which the mesh is bonded. If mesh over a given cell fails, this cell can be blocked off leaving the remainder of the screen functioning. This allows the operational life of the screen to be extended, with failure of mesh in one area not compromising the integrity of the remainder of the mesh.

The useful life of the screen needs to be as long as possible. The weight of the screen, the size of the cells and the exposed area of mesh all affect how much drilling mud can be recovered over a given time before the screen needs to be replaced in its entirety. Accordingly, current developments in screens are needed to improve the longevity of the screen to reduce cost for the overall process.

### SUMMARY

Many embodiments are directed to a screen assembly with a screen frame having a perimeter defining an interior area the frame having a longitudinal axis and wherein the perimeter comprises a leading edge and a trailing edge opposite the leading edge. The leading and trailing edges are perpendicular to the longitudinal axis of the screen frame. The frame also has lateral sides that extend parallel to the longitudinal axis of the screen frame and extend between the leading edge and the trailing edge. The leading edge is configured to facilitate movement of the screen frame with respect to a shaker system. The leading edge has a clamping surface that extends towards the interior area. The clamping surface is configured to engage with a clamping mechanism of the shaker system. The leading edge also has at least one ramp disposed at one end of the leading edge positioned adjacent to at least one of the lateral sides and the clamping surface. The screen assembly also has a screen filter coupled to the screen frame.

Other embodiments of the screen assembly include a trailing edge that has a trailing latch with an engagement surface configured to cooperatively engage with a leading latch having a corresponding leading engagement surface of a leading edge of another screen assembly.

Some embodiments are directed towards a screen assembly with a screen frame with a perimeter defining an interior area and wherein the perimeter comprises a leading edge and a trailing edge opposite the leading edge that are perpendicular to a longitudinal axis of the screen frame. The frame also has lateral sides that extend parallel to the longitudinal axis of the screen frame and extend between the leading edge and the trailing edge. The leading edge is configured to facilitate movement of the screen frame with respect to a shaker system. The assembly also has a clamping surface wherein the clamping surface is configured to engage with a clamping mechanism of the shaker system. The leading edge has a ramp that extends along the leading edge between the lateral sides with a first tapered surface that extends from the leading edge upwards towards the interior portion, the first tapered surface has a central section and two lateral sections. The lateral sections being positioned adjacent to the lateral sides and the central section being positioned between the lateral sections, wherein the central section directly transitions to the clamping surface. The assembly also has a screen filter coupled to the screen frame.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic illustration of a shaker system during installation of a screen assembly and an additional screen assembly, in accordance with an embodiment of the present disclosure;

FIG. 2 is a perspective view of a portion of the screen assembly in accordance with embodiments of the present disclosure;

FIG. 3 is a side view of a portion of the shaker system during installation of the screen assembly of FIG. 1, in accordance with an embodiment of the present disclosure;

FIG. 4 is a cross-sectional side view of a portion of the shaker system during installation of a screen assembly, in accordance with an embodiment of the present disclosure;

FIG. 5 is a cross-sectional side view of a portion of the screen assembly engaged with the additional screen assembly, in accordance with an embodiment of the present disclosure;

FIG. 6 is a perspective view of a portion of the screen assembly and a portion of an additional screen assembly, in accordance with an embodiment of the present disclosure; and

FIG. 7 is a cross-sectional perspective view of a portion of a screen assembly and an engagement with a second screen assembly, in accordance with an embodiment of the present disclosure;

FIGS. 8A and 8B are perspective top views of a screen assembly in accordance with an embodiment of the present disclosure.

FIGS. 8C and 8D are perspective bottom views of a screen assembly in accordance with an embodiment of the present disclosure.

FIGS. 8E and 8F are front and side views of a screen assembly respectively in accordance with embodiments of the present disclosure.

FIG. 9 is a cross sectional view of a portion of the screen assembly and the engagement system in accordance with embodiments

FIG. 10A illustrates an end view of a shaker system with a screen assembly in accordance with an embodiment of the present disclosure.

FIG. 10B illustrates a cross sectional view of a shaker system with a screen assembly in accordance with an embodiment of the present disclosure.

FIG. 11A illustrates a perspective view of a screen support structure in accordance with embodiments of the present disclosure.

FIG. 11B illustrates a cross-sectional view of a screen support structure in accordance with embodiments of the present disclosure.

### DETAILED DESCRIPTION

This disclosure generally relates to devices, systems, and methods for a sifting screen and a screen assembly. In many embodiments, the screen assembly can have a structure that has a leading edge and a trailing edge and two lateral sides, all of which enclose an interior portion of the assembly. The leading edge can have a ramp element or ramp and a clamping surface. The ramp can extend from the leading edge upward at an angle forming a sloped or tapered surface towards the interior portion. The clamping surface, in some embodiments, can extend from the leading edge of the towards the interior surface of the assembly. The clamping surface may be substantially flat or planar. In various embodiments, the ramp may have an additional tapered surface that extends downward towards the clamping surface. In many embodiments, the screen assembly may have an engagement portion or engagement surface that is adjacent to the clamping surface and is configured to cooperatively engage with a clamping mechanism, a portion of the clamping mechanism, or an opposing engagement surface on another screen assembly. The opposing engagement surface, in various embodiments, is positioned on the trailing edge of the assembly.

As can be appreciated, numerous embodiments of the screen assembly may be directed to the screen element and/or portions of the screen element. For example, some embodiments of the screen element may have an internal support structure that can be a mesh of structural elements that form a plurality of openings therebetween. These can facilitate the movement of fluid from one side of the screen assembly to the other.

During drilling operations, drilling fluid is pumped through a drill string into a wellbore to facilitate drilling a well. The drilling fluid can be used to drive the drilling motors and helps to maintain the temperature of the drilling components as well as facilitate the movement of drill cuttings away from the Bottom Hole Assembly (BHA). As the drilling fluid is used it flows through an annular space defined between the drill string and the wellbore to return to processing equipment located at a surface. The drilling fluid carries cuttings from the wellbore to the processing equipment located at the surface, and it is often desirable to separate the drilling fluid from the cuttings in order to recycle (e.g., reuse) the drilling fluid.

One piece of processing equipment that is used at the surface is a shaker. A shaker (e.g., shale shaker; vibratory separator; shaker system) is a vibrating sieve-like table or deck that separates solids (e.g., the cuttings) from the drilling fluid. In operation, the drilling fluid that carries the cuttings is deposited at the feed end of the shaker. As the drilling fluid travels along a length of the shaker, the drilling fluid falls through perforations in a screen filter of a screen assembly to a reservoir and the solids are conveyed via vibration along the screen assembly to a discharge end of the shaker.

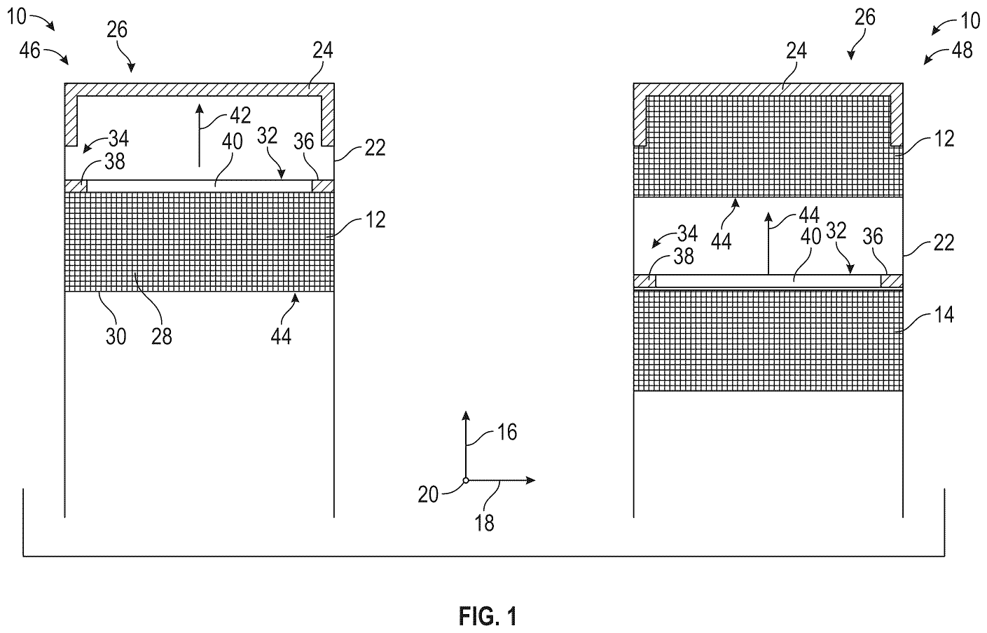

FIG. 1 is a schematic illustration of a shaker system 10 during installation of a screen assembly 12 and an additional screen assembly 14, in accordance with an embodiment of the present disclosure. To facilitate discussion, the shaker system 10 and/or components therein may be described with reference to a longitudinal axis or direction 16, a lateral axis or direction 18, and/or a vertical axis or direction 20. It should be appreciated that, when installed in the shaker system 10, the screen assembly 12 and the additional screen assembly 14 may be at an angle relative to a ground surface, and in certain embodiments, the angle may be adjustable.

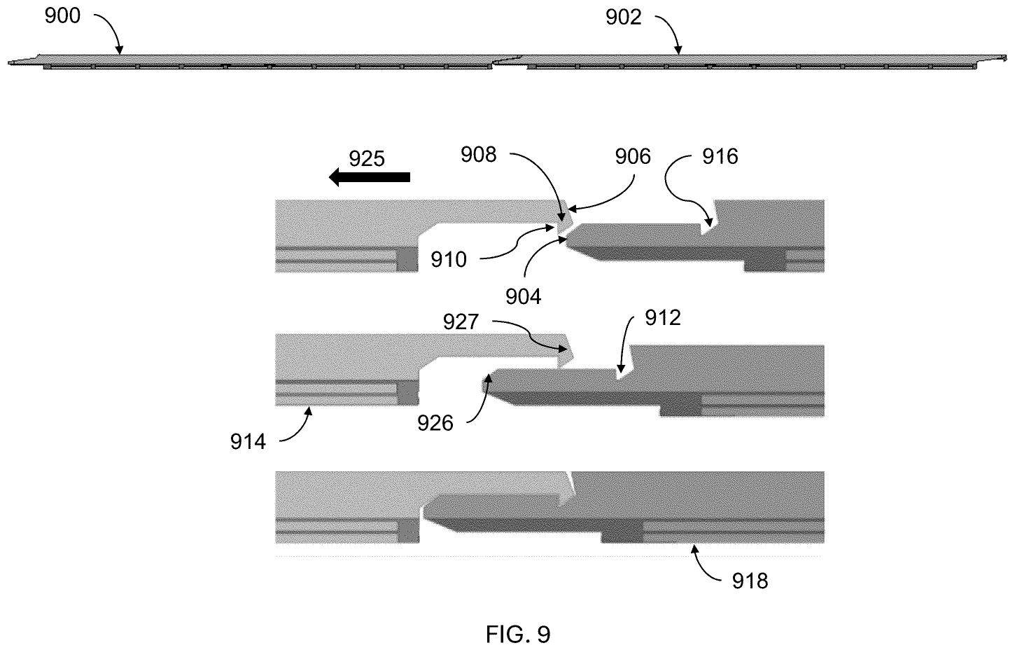

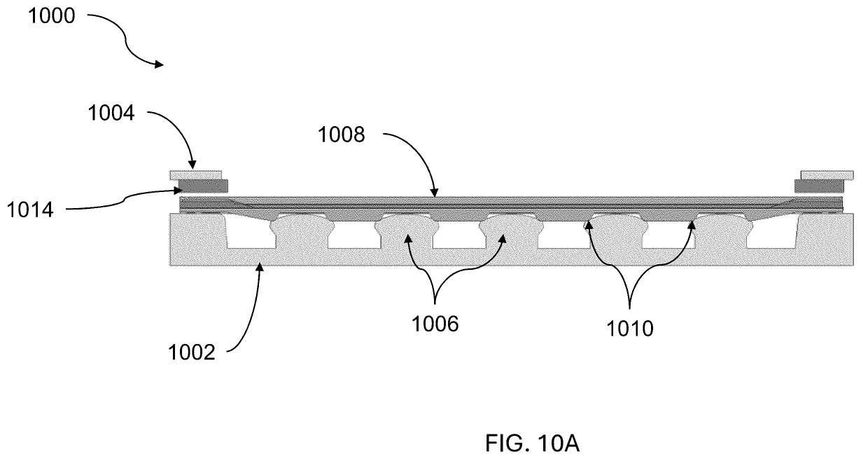

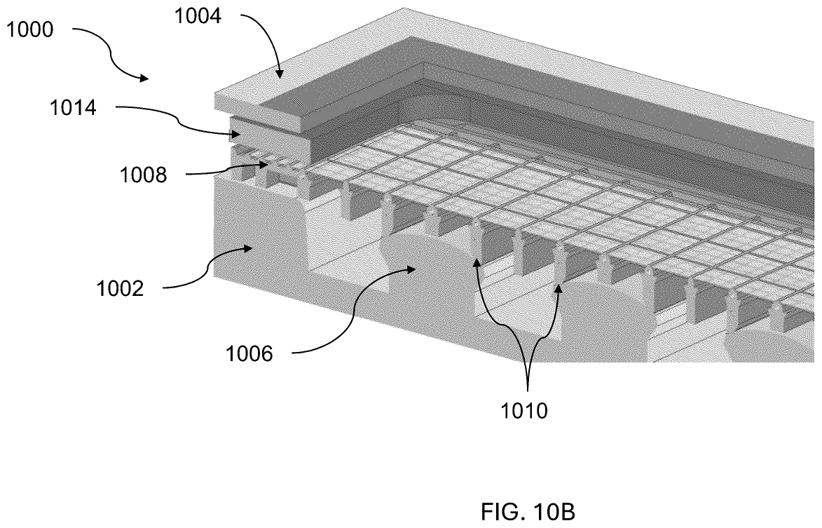

As shown, the shaker system 10 includes a shaker frame 22 and a clamp 24 coupled to the shaker frame 22. In various embodiments, the shaker frame may include a number of different support elements, illustrated in FIGS. 9 and 10, that are configured to support each of the various screen assemblies. In many embodiments, the claim 24 can be considered a clamping system or clamping mechanism that can have various components used to apply a clamping force onto a portion of the screen assembly 12. In certain embodiments, the clamp 24 is a pneumatic device such as an inflatable bladder formed by a membrane that defines an enclosed volume. For example, the membrane may be resilient (e.g., clastic, flexible), such that a volume and/or shape of the inflatable bladder changes depending on air pressure therein. The clamp 24 may be positioned at or proximate to a first end 26 (e.g., feed end; clamp end; first end portion) of the shaker frame 22. As shown, the clamp 24 may extend laterally along the first end 26 and/or longitudinally from the first end 26 along at least a portion of opposite lateral sides of the shaker frame 22.

The screen assembly 12 may include a filter 28 (e.g., mesh; screen filter), coupled to a frame 30 (e.g., screen frame). The frame 20 may include a leading edge 32 (e.g., leading edge portion; first end; first end portion). Further, the leading edge 32 may include or define a ramp 34, which may include multiple ramp portions. In other words, in some embodiments the ramp may be a single ramp with various features or elements that can facilitate the engagement of the screen assembly with the shaker and in some embodiments, the ramp may be two distinct ramps on opposing sides of the screen assembly. For example, in FIG. 1, the ramp 34 includes a first ramp portion 36 (e.g., first ramp) and a second ramp portion 38 (e.g., second ramp) on opposite lateral sides of the leading edge 32. The leading edge 32 may also include a clamping surface 40, which may extend laterally between the first ramp portion 36 and the second ramp portion 38. In some embodiments, the clamping surface may be recessed element or a substantially planar surface.

As described herein, the ramp 34 may facilitate installation of the screen assembly 12 into the shaker frame 22. In particular, to install the screen assembly 12 into the shaker frame 22, an operator (e.g., human or machine operator) may move the screen assembly 12 toward the first end 26 of the shaker frame 22, as shown by arrow 42 in a first representation 46 of FIG. 1 (e.g., at a first time or stage of screen installation operations). The ramp 34 facilitates sliding the screen assembly 12 relative to the clamp 24 (e.g., under the clamp 24; between a surface of the shaker frame 22 and the clamp 24)) so that the screen assembly 12 is fully installed at the first end 26 of the shaker frame 22 and so that the clamp 24 may adequately engage and hold the screen assembly 12 at the first end 26 of the shaker frame 22.

As can be appreciated, in some embodiments of the shaker system 10 clamps and clamp mechanisms in the form of an inflatable bladder can stretch over time. This can impede the path for the screen assembly 12 as it is inserted into the shaker system 10. Accordingly, the ramp 34 or ramps may help facilitate the movement of the screen assembly so that it can be fully inserted by providing a surface that can move the stretched bladder and allow for full insertion of the screen assembly. Thus, the screen assembly 12 with the ramp 34 may slide under the clamp 24 and/or lift the clamp 24 so that the screen assembly 12 can be fully installed at the first end 26 of the shaker frame 22. Additionally, the ramp 34 can allow the clamp 24 to adequately engage and hold the screen assembly 12 at the first end 26 of the shaker frame 22, even if the clamp 24 is stretched or blocks the path of the screen assembly 12. Further, the screen assembly 12 with the ramp 34 may slide under the clamp 24 to be fully installed at the first end 26 of the shaker frame 22, which may block over-inflation of the clamp 24 (and further undesirable stretching), and also the ramp 34 may reduce a chance of puncturing or damaging the clamp 24 with the screen assembly 12 during screen installation operations.

As can be appreciated, the ramp may have any number of shapes and/or forms that can provide a gradual surface that can prevent future damage to a bladder type clamping system as well as potentially damage the screen assembly 12. Additionally, the ramp, in any desirable shape, can help ensure the proper insertion and engagement of the screen assembly 12 with the shaker system as well as with other screen assemblies that can improve the longevity of the screen assembly.

Additionally, as shown in FIG. 1, once the screen assembly 12 is fully installed at the first end 26 of the shaker frame 22 and secured via the clamp 24, the operator may move the additional screen assembly 14 toward the first end 26 of the shaker frame 22 as shown by arrow 44 in a second representation 48 of FIG. 1 (e.g., at a second time or stage of screen installation operations). For manufacturing and/or operational efficiency, the additional screen assembly 14 may have a same shape (e.g., configuration; geometry) as the screen assembly 12. This can help to improve manufacturing costs and overall maintenance costs for the system. For example, the additional screen assembly 14 may include a respective leading edge 32 with a respective ramp 34, which may include a respective first ramp portion 36 and a respective second ramp portion 38. The additional screen assembly 14 may include the respective leading edge 32 with a respective clamping portion 40. The respective leading edge 32 of the additional screen assembly 14 may slide under and engage a trailing edge 44 (e.g., trailing edge portion; second end; second end portion) of the screen assembly 12. As described herein, the additional screen assembly 14 and the screen assembly 12 may align with one another via corresponding tapered surfaces and/or latch to one another via one or more latches.

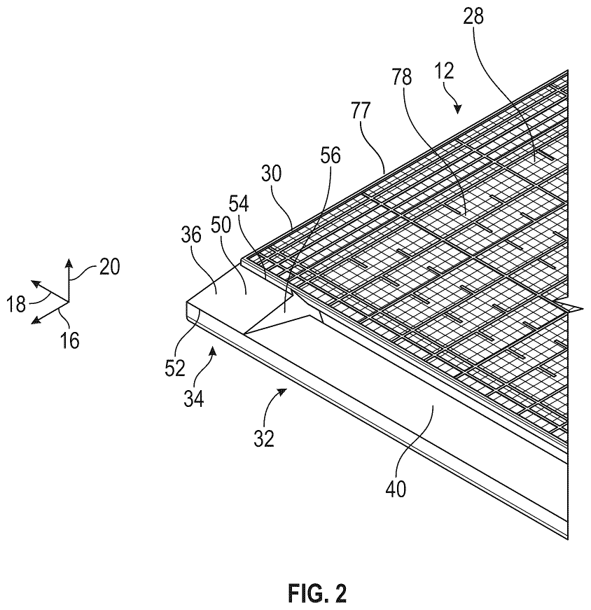

Referring now to FIG. 2 a perspective view of a portion of the screen assembly 12, in accordance with an embodiment of the present disclosure is shown. The screen assembly 12 may include a filter 28, as well as the frame 30. The frame 30 can be made up of a leading edge 32 and a trailing edge 44 and two lateral sides 77. The frame 30 can also form an interior area 78 that is positioned below the filter 28 or screen. In numerous embodiments, the leading edge 32 may include or define the ramp 34, which may include multiple ramp portions that are positioned at opposing ends of the frame 30 and are positioned adjacent to the lateral sides 77. For example, in FIG. 2, the first ramp portion 36 is shown at one lateral side of the leading edge 32 and adjacent to one lateral side 77 of the frame 30. The leading edge 32 may also include the clamping surface 40, which may extend laterally between the first ramp portion 36 and the second ramp portion 38 (see FIG. 1). Additionally, in many embodiments the clamping surface 40 may be substantially flat or planar. In other embodiments, the clamping surface may be contoured to cooperatively engage with a clamping mechanism or clamp. As illustrated in FIG. 2, the clamping surface 40 is directly adjacent to the leading edge. In other words, the clamping surface 40 extends from the leading edge towards the interior portion 78 of the frame 30. In some embodiments, the clamping surface 40 may extend directly from the leading edge 32, but rather may extend from another surface such as a ramp or tapered surface and extend towards the interior portion.

FIG. 2 further illustrates other features of the ramp 34. For example, in many embodiments, the first and second ramp portions 36 (38) includes a tapered surface 50 (e.g., upper surface). The tapered surface 50 tapers toward the leading edge 32 (e.g., a first end 52 of the tapered surface is adjacent to the leading edge 32 and below a second end 54 of the tapered surface 50 along the vertical axis 20 of the screen assembly 12; the tapered surface 50 is at an angle relative to the longitudinal axis 16 of the screen assembly 12). In other words, the tapered surface 50 extends upward at an angle towards the interior portion 78 of the frame 30. It should be appreciated that the second ramp portion 38 (see FIG. 1) includes a respective tapered surface 50 that includes the same or similar shape (e.g., configuration; geometry) as the tapered surface 50 of the first ramp portion 36. Such symmetrical designs can aid in the insertion of the screen assembly into the shaker system.

Additionally, the ramp 34 may have an additional tapered surface 56 (e.g., centering surface) or additional surfaces that may extend laterally between the tapered surface 50 of the first ramp portion 36 and the clamping surface 40. It should be appreciated that a respective or corresponding additional tapered surface 56 may extend laterally between the respective tapered surface 50 of the second ramp portion 38 (see FIG. 1) and the clamping surface 40, and the respective additional tapered surface 56 includes a corresponding shape (e.g., configuration; geometry; opposite taper) as the additional tapered surface 56 that extends laterally between the tapered surface 50 of the first ramp portion 36 and the clamping surface 40.

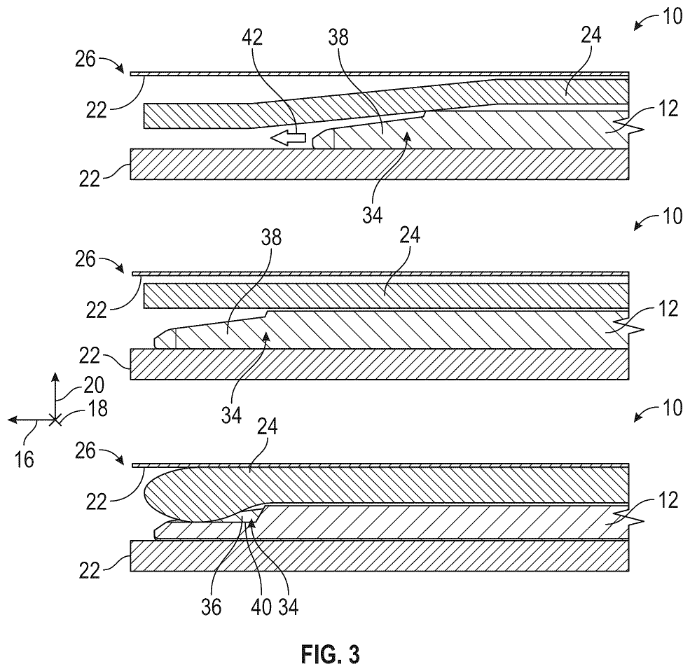

FIG. 3 is a side view of a portion of the shaker system 10 during installation of the screen assembly 12, in accordance with an embodiment of the present disclosure. As described herein, the screen assembly 12 may include the ramp 34 to facilitate installation of the screen assembly 12 into the shaker frame 22. In particular, to install the screen assembly 12 into the shaker frame 22, an operator may move the screen assembly 12 toward the first end 26 of the shaker frame 22 as shown by the arrow 42. The ramp 34 facilitates sliding the screen assembly 12 under the clamp 24 so that the screen assembly 12 is fully installed at the first end 26 of the shaker frame 22 and so that the clamp 24 can adequately engage and hold the screen assembly 12 at the first end 26 of the shaker frame 22. Once the screen assembly 12 is positioned under the clamp 24, the clamp 24 may be actuated (e.g., inflated; filled with air) to contact and hold the screen assembly 12 within the shaker frame 22.

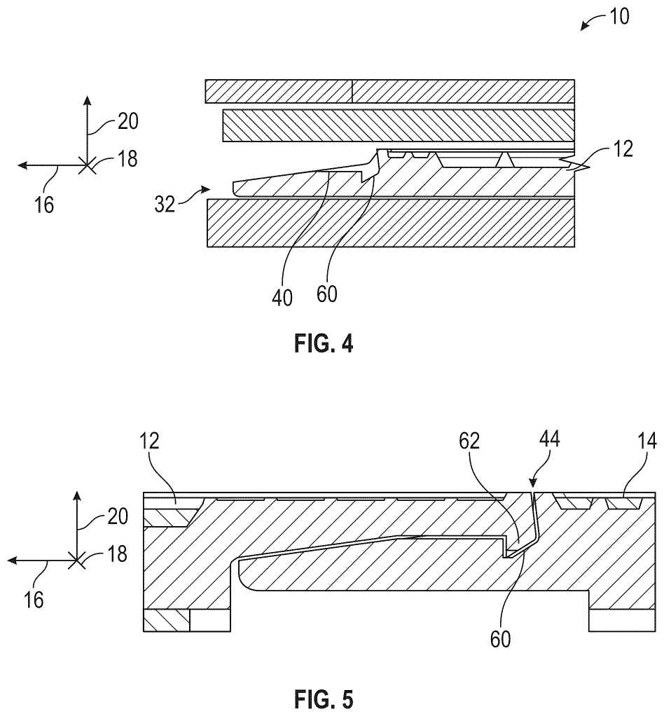

FIG. 4 is a cross-sectional side view of a portion of the shaker system 10 during installation of the screen assembly 12, in accordance with an embodiment of the present disclosure. In certain embodiments, the leading edge 32 of the screen assembly 12 may include one or more first latches 60 (e.g., latch features; recesses; slots). The latches 60 may take any form and may have one or more engagement surface 65 that are configured to cooperatively engage with a corresponding engagement mechanism on the trailing end of another screen. For example FIG. 5 illustrates a cross-sectional view of the trailing edge 44 of a first screen assembly 12 cooperatively engaged with a leading edge 32 of another screen assembly 14. The leading edge 32 can have a latch 60 or latch mechanism that is positioned between the interior portion 78 and the clamping surface 40. Likewise, the trailing edge 44 of the screen assembly 12/14 can have a corresponding latching mechanism 62. The latching mechanism can have one or more engagement surfaces 63 that are configured to cooperatively engage with corresponding engagement surfaces 64 of the latch on the leading edge 32. This allows the various screen assemblies 12/14 to be coupled to each other. Additionally, the latches or latching mechanisms on the corresponding screen assemblies can be helpful in ensuring that the screen assemblies are properly aligned with each other and the shaker system.

Thus, with reference to FIGS. 1 and 5, the screen assembly 12 and the additional screen assembly 14 with a same or similar shape may be installed within the shaker frame 22 of the shaker system 10. In particular, the screen assembly 12 may be fully inserted into the shaker frame 22 to enable the clamp 24 to engage and hold the screen assembly 12 within the shaker frame 22, and the additional screen assembly 14 may be coupled to the screen assembly 12 via a latch interface or engagement surface formed by the latches on the leading edge of the additional screen assembly 14 and the corresponding latches 62 of the first screen assembly 12.

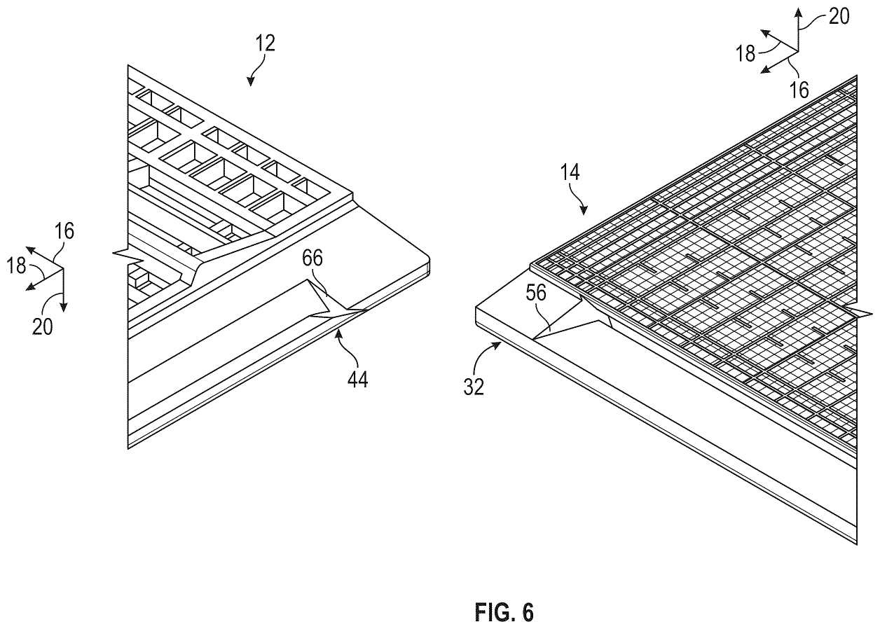

FIG. 6 is a perspective view of a portion of the screen assembly 12 and a portion of the additional screen assembly 14, in accordance with an embodiment of the present disclosure. As shown, the trailing edge 44 of the screen assembly 12 and the respective leading edge 32 of the additional screen assembly 14 include corresponding surfaces (56, 66) to facilitate centering and engagement between the screen assembly 12 and the additional screen assembly 14. For example, the additional screen assembly 14 includes a respective additional tapered surface 56 that contacts and engages a corresponding tapered surface 66 of the screen assembly 12. It should be appreciated that a respective additional tapered surface 56 may be provided on the additional screen assembly 14 to contact and engage another corresponding tapered surface 66 of the screen assembly 12 to thereby facilitate centering and alignment between the additional screen assembly 14 and the screen assembly 12 (e.g., along the lateral axis 18).

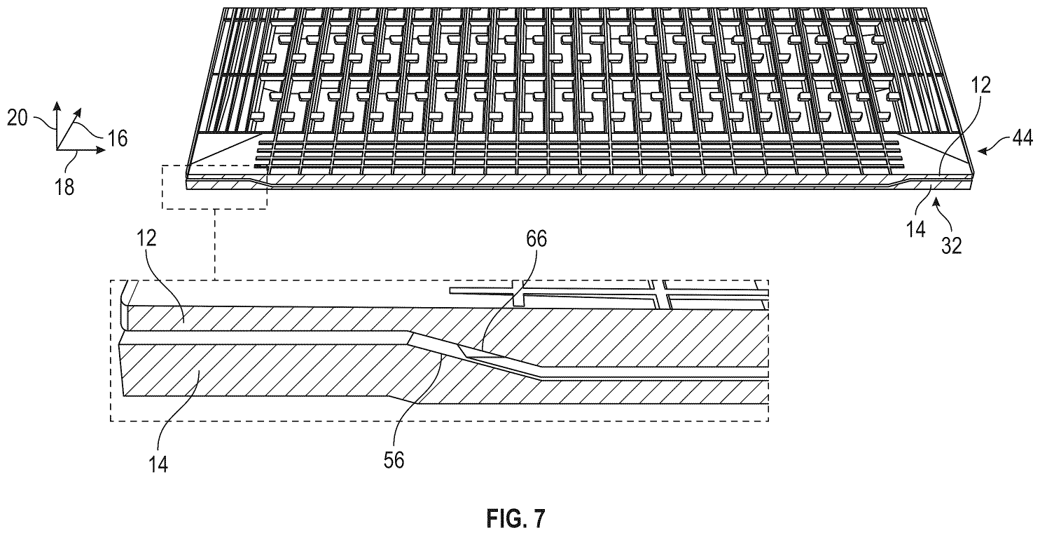

FIG. 7 illustrates a cross-sectional perspective view of a portion of the screen assembly 12 and a portion of the additional screen assembly 14, in accordance with an embodiment of the present disclosure. As shown, the trailing edge 44 of the screen assembly 12 and the respective leading edge 32 of the additional screen assembly 14 include corresponding surfaces to facilitate centering and engagement between the screen assembly 12 and the additional screen assembly 14. For example, the additional screen assembly 14 includes the respective additional tapered surface 56 that contacts and engages the corresponding tapered surface 66 of the screen assembly 12. It should be appreciated that a respective additional tapered surface 56 may be provided on the additional screen assembly 14 to contact and engage another corresponding tapered surface 66 of the screen assembly 12 to thereby facilitate centering and alignment between the additional screen assembly 14 and the screen assembly 12 (e.g., along the lateral axis 18).

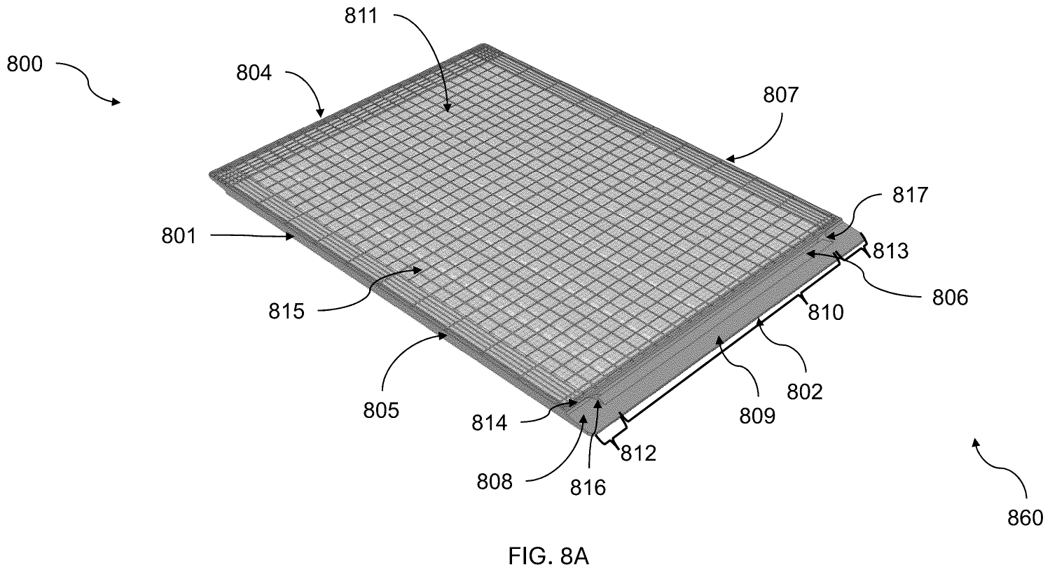

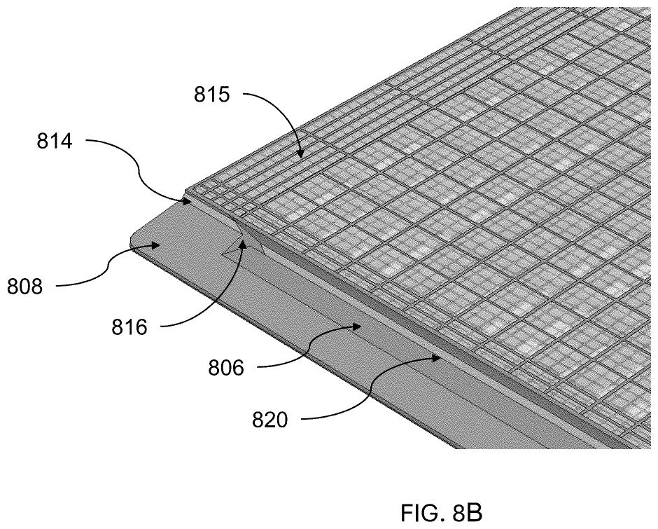

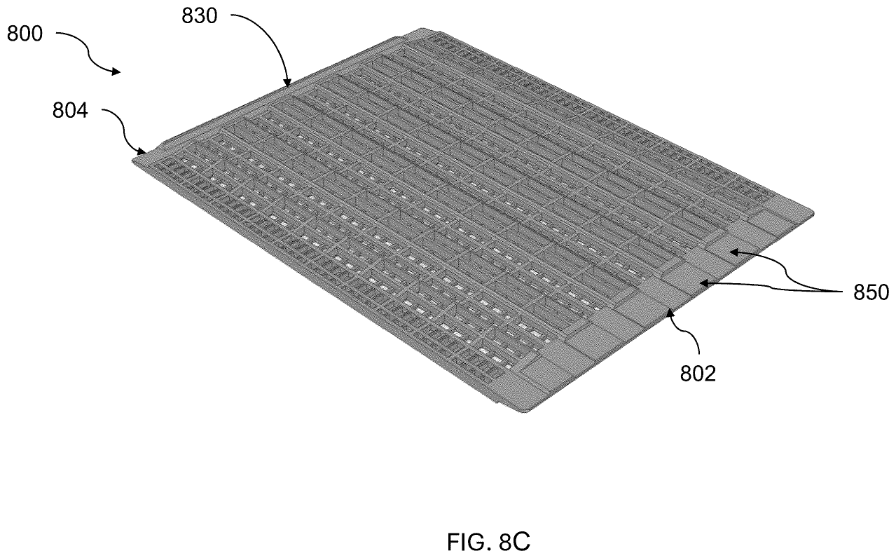

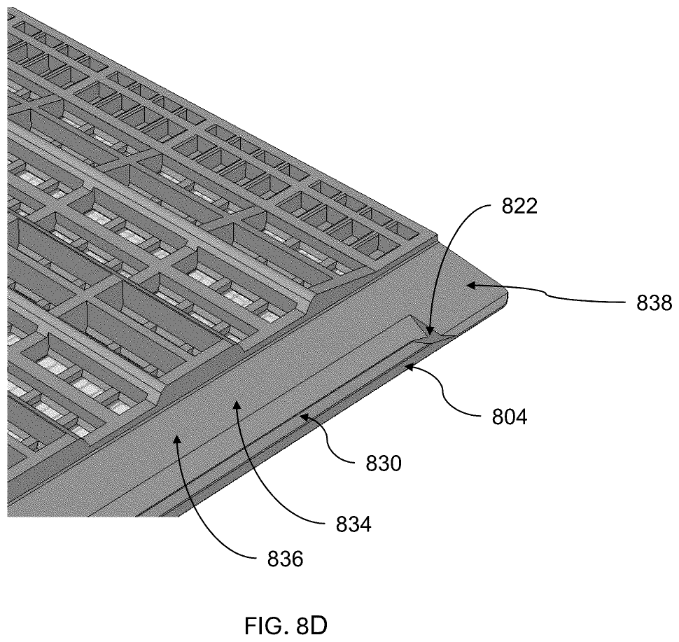

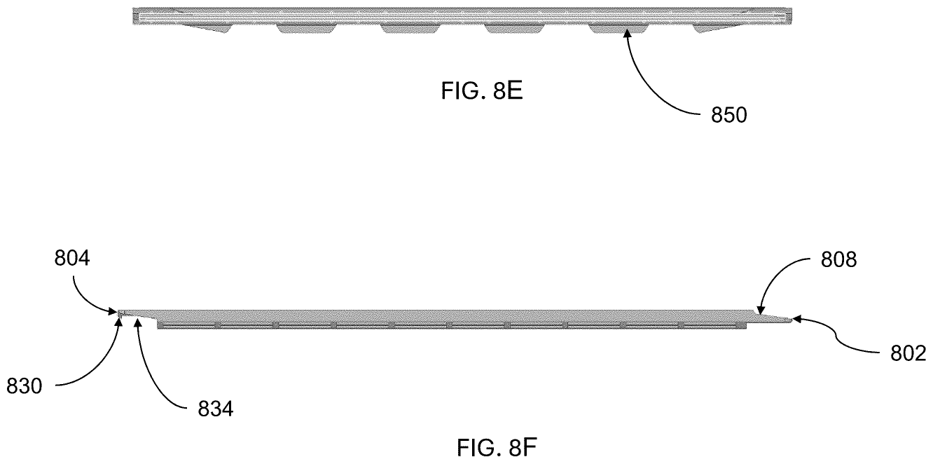

Referring now to FIG. 8A, a perspective view of a screen assembly 800 is illustrated. As illustrated in other embodiments, the screen assembly 800 can have a frame 801 with a leading edge 802 and a trailing edge 804 with corresponding and opposing lateral sides 805/807 forming an interior portion 811. In many embodiments the screen assembly 800 can have clamping surface 806 that is substantially planar and is configured to engage with a clamping mechanism of a shaker system. The clamping mechanism, can be any suitable mechanism that engages with and holds the screen assembly 800 in place within a shaker system.

Embodiments of the screen assembly can also have a ramp 808 integrated into the leading edge 802 of the assembly. In other words, the ramp 808 may extend along the leading edge 802 and directly adjacent thereto. The ramp runs laterally between the lateral sides 805/807 of the frame 801. The ramp 808 can have a first tapered surface 809 that extends upwards away from the leading edge 802 towards an interior portion 811 of the frame. In many embodiments, the ramp 808 may have multiple sections. For example, the ramp 808 may have a central section 810 and two lateral sections 812/813 respectively. As illustrated in FIG. 8A, the central section 809 has a tapered surface that directly transitions into the clamping surface 806. The lateral sections 812/813 respectively extend upward at an angle with respect to the longitudinal axis of the screen assembly till they intersect a portion of the frame near the interior portion 811. In some embodiments, this may be at or near the interface 814 between the screen filter 815 and the frame. As can be appreciated, the lateral sections may have any variety of surface configurations at the interface 814 so that the frame 801 can accommodate and be coupled with the screen filter 815.

In various embodiments, the ramp 808 may have additional or secondary tapered surfaces 816/817 respectively. For example, FIG. 8A illustrates secondary tapered surfaces 816/817 of the ramp 808 that extend off the first tapered surface downward towards the clamping surface 806. The secondary tapered surfaces 816/817 may be configured or shaped such that they aid in the centering or positioning of the screen assembly 800 into a shaker system. In other words, the secondary tapered surfaces 816/817 are self-centering surfaces. FIG. 8B further illustrates a closer view of the ramp 808 with one of the secondary surfaces 816.

Moreover, FIG. 8B illustrates an embodiment of a screen assembly 800 that can have a latch system, or engagement feature 820 that can engage with another screen assembly (shown in FIG. 9). This can be considered the leading latch 820. The leading latch and/or engagement feature 820 will be more fully described with respect to FIG. 9. However, as can be appreciated, the leading latch system or engagement feature 820 is positioned at a transition point from the clamping surface of the leading edge 802 of the screen assembly 800. This referring more the top view of the screen assembly 800. Likewise, the trailing edge 804 can have an equal and opposite engagement feature that can help align and connect one screen assembly with another.

For example, FIGS. 8C and 8D illustrate bottom views of a screen assembly in accordance with embodiments of the present disclosure. From the bottom view, it can be illustrated that the trailing edge 804 of the screen assembly 800 has a corresponding engagement feature 830 that can be considered a trailing latch. The trailing latch 830 can be configured with an equal and opposite shape as the leading latch 820 such that the leading latch 820 of one screen assembly can cooperatively engage with the trailing latch 830 of another screen assembly. Additionally, the trailing latch 830 can have one or more corresponding latch tapered surfaces 822 that correspond to or engage with the secondary surfaces 816/817 of the leading edge 802 ramp 808. This can help to self-center each of the screen assemblies 800 as they are inserted into a shaker system so that they do not become misaligned. As can be appreciated, the trailing latch 830 can have a mirrored configuration from the leading latch system that may include a trailing ramp 834. The trailing ramp will also have a central section 836 and two lateral sections 838 that engage with the central and lateral sections (810, 812, 813) respectively. The mirrored configuration helps to ensure the different screen assemblies are properly aligned with respect to each other. This will ensure a more efficient system of screen assemblies and a more efficient shaker system.

Additionally, in some embodiments of a screen assembly, the bottom surface (FIGS. 8C and 8D) can have secondary support elements 850 that can correspond with support structures of the shaker system. The support elements 850 can be a protrusion that may have any suitable configuration with one or more engagement points. Additionally, the support elements 850 may run generally parallel with the longitudinal axis of the screen assembly. The support elements help to not only support the screen assembly, but align the assembly within a shaker system. This may be more fully appreciated with respect to FIGS. 10A and 10B. FIGS. 8E and 8F illustrate front and side views of a screen assembly in accordance with numerous embodiments. It can be seen in FIG. 8F how the front 808 and rear 834 ramps have substantially equal and opposite angles so that they can cooperatively engage with another screen assembly.

FIG. 9 is an illustration of an embodiment of the engagement mechanisms of two distinct screen assemblies 900 and 902. The top portion of FIG. 9 illustrates two screen assemblies 900 and 902 in their engaged state where the leading edge 904 of one assembly 902 is cooperatively engaged with the trailing edge 906 of another assembly 900. The bottom portion of FIG. 9 illustrates a zoomed in portion of the engagement of the two opposing ends of the screen assemblies. As can be appreciated, the trailing edge 906 of a first assembly 900 can have a latch or trailing latch 908 that has one or more engagement surfaces 910. The trailing engagement surfaces 910 may be in the form of a protrusion or extension of the trailing edge 906 that extend downwards towards the bottom surface 914 of the first screen assembly 900. Likewise, the leading edge 904 of the second assembly 902 can have a corresponding latch or leading latch 912 that has one or more corresponding engagement surfaces 916. The leading latch engagement surfaces 916 may be in the form of a depression that extend downward towards the bottom surface 918 of the second screen assembly 902. Accordingly, in many embodiments, the second screen assembly 902 can move in the direction of the arrow 925 to engage with the first screen assembly 900. In order to further facilitate the movement and engagement of the two screen assemblies, the trailing and leading edges may have a ramped edge 926/927. The ramped edge 926/927 can be a small chamfer or may be a larger extended ramp. It should be appreciated that the ramp can take on any suitable configuration that can facilitate the engagement of the screen assemblies with another screen assembly or a shaker system. It should also be understood that the ramp may be a curved surface rather than a tapered surface.

FIGS. 10A and 10B illustrate a front view and a perspective view of a shaker system 1000 respectively. The shaker system 1000 can be configured with a support structure 1002 and a clamping structure 1004. The support structure 1002 can be configured with one or more screen assembly supports 1006 that can support the screen assembly 1008 at one or more support points 1010. The clamping structure 1004 can have a top element 1012 and a clamping mechanism 1014. The clamping mechanism 1014 can be configured to engage with one or more surfaces of the screen assembly 1008.

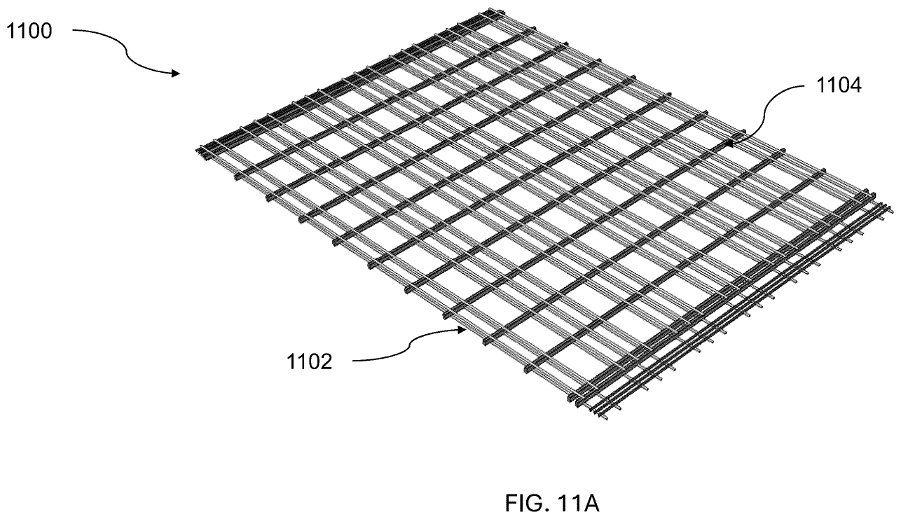

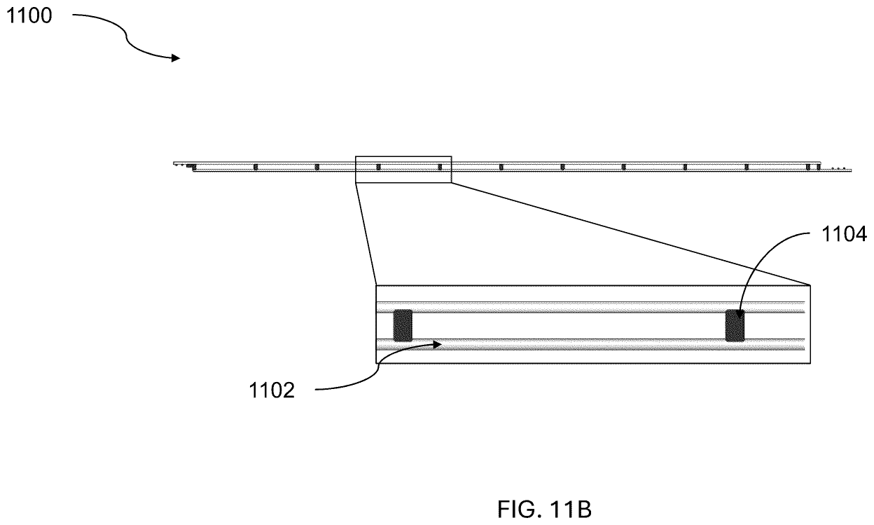

As should be understood, embodiments of the screen assembly may include a screen filter. The screen filter can include a mesh structure that is designed to allow fluid to flow through the screen assembly while filtering out larger cuttings from the drilling operation. Many embodiments of the screen filter may have an internal support structure as illustrated in FIGS. 11A and 11B. For example, the support structure of the screen filter, according to various embodiments, has a network of longitudinal 1102 and perpendicular 1104 elements. The longitudinal 1102 and perpendicular 1104 elements form a network of openings that sit beneath the mesh. In some embodiments, the network can be multi-layered. For example, FIG. 11B illustrates an upper layer of supports 1106 and a lower layer of supports 1108. The upper and lower layers are separated by an internal layer 1110 of supports. In many embodiments, the upper and lower layers 1106/1108 may be made up of longitudinal elements while the internal layer 1110 is made up of perpendicular elements. As can be appreciated, the internal support structure 1100 is generally configured to be part of the screen filter. In some embodiments, the screen filter may be removable while other embodiments may have an integrated screen filter that is integrated within a body of a screen assembly. Furthermore, it should be appreciated that the perpendicular and longitudinal supports can be made of any suitable material such as metal, composite, plastic, etc.

It should be understood that the features of the various embodiments of the screen assembly and/or the screen filter and/or the shaker system and the manner in which the screen assemblies and shaker system engage with each other, as illustrated in the various figures are not meant to be all inclusive and merely demonstrative of various embodiments. Some or all of the features of the screen assemblies and/or shaker systems may be combined and/or separated in accordance with various embodiments.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” or “many embodiments” etc. of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A screen assembly, comprising:
a screen frame having a perimeter defining an interior area having a longitudinal axis and wherein the perimeter comprises a leading edge and a trailing edge opposite the leading edge that are perpendicular to the longitudinal axis of the screen frame, and lateral sides that extend parallel to the longitudinal axis of the screen frame and extend between the leading edge and the trailing edge,
wherein the leading edge is configured to facilitate movement of the screen frame with respect to a shaker system;
a clamping surface extending towards the interior area wherein the clamping surface is configured to engage with a clamping mechanism of the shaker system;
at least one ramp disposed at one end of the leading edge positioned adjacent to at least one of the lateral sides and the clamping surface; and
a screen filter coupled to the screen frame.

2. The screen assembly of claim 1, wherein the ramp comprises at least a first tapered surface extending from the leading edge upwards towards the interior area.

3. The screen assembly of claim 2, wherein the ramp comprises a second tapered portion that extends downward from the first tapered surface towards the clamping surface wherein the second tapered surface is configured to self-center the frame within a shaker system.

4. The screen assembly of claim 1, further comprising a second ramp disposed opposite the first ramp adjacent to the other lateral side and the clamping surface.

5. The screen assembly of claim 4, wherein the second ramp comprises corresponding tapered surfaces configured to self-center the frame within a shaker system.

6. The screen assembly of claim 1, wherein the trailing edge further comprises a trailing latch with an engagement surface configured to cooperatively engage with a leading latch having a corresponding leading engagement surface of a leading edge of another screen assembly.

7. The screen assembly of claim 6, wherein the engagement surface comprises a protrusion that is configured to cooperatively engage with a corresponding depression on the corresponding engagement surface of the leading edge of the another screen assembly.

8. The screen assembly of claim 1, wherein the screen filter comprises a plurality of structural support elements, wherein a portion of the structural support elements are disposed parallel to the longitudinal axis of the screen frame and a portion of the structural elements are disposed perpendicular to the longitudinal axis of the screen frame, thereby forming a plurality of openings between the plurality of structural elements.

9. The screen assembly of claim 8, wherein the screen filter is disposed over the interior portion.

10. The screen assembly of claim 1, wherein the screen filter is disposed over the interior portion.

11. A screen assembly comprising:
a screen frame having a perimeter defining an interior area having a longitudinal axis and wherein the perimeter comprises a leading edge and a trailing edge opposite the leading edge that are perpendicular to the longitudinal axis of the screen frame, and lateral sides that extend parallel to the longitudinal axis of the screen frame and extend between the leading edge and the trailing edge,
wherein the leading edge is configured to facilitate movement of the screen frame with respect to a shaker system;
a clamping surface wherein the clamping surface is configured to engage with a clamping mechanism of the shaker system;
a ramp that extends along the leading edge between the lateral sides having a first tapered surface that extends from the leading edge upwards towards the interior portion, the first tapered surface having a central section and two lateral sections, the lateral sections being positioned adjacent to the lateral sides and the central section being positioned between the lateral sections, wherein the central section directly transitions to the clamping surface; and
a screen filter coupled to the screen frame.

12. The screen assembly of claim 11, wherein the ramp comprises secondary tapered surfaces disposed at opposing lateral ends of the ramp and extend downward towards the clamping surface from the first tapered surface.

13. The screen assembly of claim 11, further comprising an engagement surface disposed at an internal end of the clamping surface near the interior portion, the engagement surface having a depression.

14. The screen assembly of claim 13, wherein the trailing edge has an engagement element configured to cooperatively engage with an engagement surface of another screen assembly.

15. The screen assembly of claim 11, wherein the screen filter comprises a plurality of structural support elements, wherein a portion of the structural support elements are disposed parallel to the longitudinal axis of the screen frame and a portion of the structural elements are disposed perpendicular to the longitudinal axis of the screen frame, thereby forming a plurality of openings between the plurality of structural elements.

16. The screen assembly of claim 15, wherein the screen filter is disposed over the interior portion.

17. The screen assembly of claim 11, wherein the screen filter is disposed over the interior portion.

18. A fluid separation system comprising:
a shaker;
a screen assembly further comprising a screen frame having a perimeter defining an interior area having a longitudinal axis and wherein the perimeter comprises a leading edge and a trailing edge opposite the leading edge that are perpendicular to the longitudinal axis of the screen frame, and lateral sides that extend parallel to the longitudinal axis of the screen frame and extend between the leading edge and the trailing edge,
wherein the leading edge is configured to facilitate movement of the screen frame with respect to a shaker system;
a clamping surface extending towards the interior area from the leading edge wherein the clamping surface is configured to engage with a clamping mechanism of the shaker system;
at least one ramp disposed at one end of the leading edge positioned between at least one of the lateral sides and the clamping surface; and
a screen filter coupled to the screen frame.

19. The fluid separation system of claim 18, wherein the trailing edge further comprises an engagement surface configured to cooperatively engage with either the clamping mechanism or a corresponding engagement surface of a leading edge of another screen assembly.

20. The fluid separation system of claim 19, wherein the engagement surface comprises a protrusion that is configured to cooperatively engage with a corresponding depression on the corresponding engagement surface of the leading edge of the another screen assembly
